(19) United States
(12) Patent Application Publication
(10) Pub. No.: US 2003/0043996 A1
(43) Pub. Date: Mar. 6, 2003

(54) Magnetically activated electric filter apparatus

(76) Inventors: Stephen Michael Sedio, Valley Center, CA (US); Richard Lao, San Diego, CA (US)

Correspondence Address: Squire, Sanders & Dempsey L.L.P., 14th Floor, 801 S. Figueroa Street, Los Angeles, CA, 90017-5554, US

(21) Appl. No.: 09/947,270

(22) Filed: Sep. 5, 2001

(51) Int. Cl. H04M 1/00; H04M 9/00

(52) U.S. Cl. 379/390.02

(57) ABSTRACT

This invention relates generally to electronic filter circuits on POTS (Plain Old Telephone System) lines and more particularly to an electronic filter circuit which contains a magnetically activated switch. The switch enables multiple POTS device micro-filter combinations to be simultaneously active without the drawbacks of the prior art.

### BACKGROUND OF THE INVENTION

1. Field of the Invention

This invention relates generally to electronic filter circuits on Plain Old Telephone System (POTS) lines and more particularly to an electronic filter circuit which contains a magnetically activated switch. The switch enables multiple POTS devices with their associated filters to be simultaneously active on a POTS line without causing undesirable signal attenuation.

This invention further relates to any communication lines or data lines which are functionally equivalent to POTS lines, but usually not included within the scope of POTS. Functional equivalence in this context is intended to include electrical signals of any frequency and for any application that are used in a way similar to the POTS signals described here

2. General Background and State of the Art

Digital Subscriber Line (DSL) has gained widespread popularity as a technology in which advanced modems are used to increase data transmission speeds over regular telephone lines, sometimes referred to as a Plain Old Telephone System (POTS) lines. DSL, as used in this document, is understood to include, but is not limited to, various modes of DSL known as HDSL, ADSL, VDSL. In any establishment using a POTS line, such as for example residential homes and office complexes, communications devices such as telephones, facsimile machines, DSL modems and other devices are typically connected in parallel across the common POTS line.

Deployment of DSL modems on a POTS line requires the installation of filters on all of the POTS communication devices on the line. The filter blocks certain frequencies ensuring that voice transmission over the telephone lines is not disturbed during data transmission by a DSL modem. However, each filter connected to a POTS device constitutes an electrical load on the POTS line. This electrical load causes attenuation of the electrical signal, resulting in increased signal reception errors and degraded DSL performance.

Specifically, the filter typically contains an electrical capacitor that bypasses a portion of the electrical signal around the receiving circuitry. This capacitor may cause attenuation of the electrical signal(s) going through the POTS line even when the device to which the filter capacitor is connected to is not in use. If multiple telephones, facsimile machines, DSL modems, and/or other POTS communication devices are connected to the same DSL line, each with its own filter, undesirable attenuation of the incoming DSL signal may occur due to the shunting effect of the capacitors in the filters. However, if a POTS device is not in use, there is no need for the filtering function and for the filter capacitor.

Existing filters may use active and/or solid state components to switch off the capacitor when the POTS device to which it is attached is not in use. However, these filters are relatively expensive, and may draw power when the phone is on-hook which may confuse telephone company switching circuits. Moreover, solid state devices are susceptible to transient voltages.

Therefore, there is a need for a passive electronic filter circuit that enables a large number of POTS communication device filters to be simultaneously active on one physical interface between a switched telephone network and a customer POTS line. That is, there is a need for a passive electronic filter circuit in which the filter capacitor may be activated and deactivated. Also, there is a need for a filter that does not require power, can be produced at a lower cost than the prior art active filters, and is electronically simpler than the prior art active filters.

### INVENTION SUMMARY

One of the features of the present invention is to provide a passive electronic filter circuit that enables a large number of POTS devices with filters to be simultaneously active on one POTS line without the capacitors in the filters causing attenuation of a DSL signal. In one exemplary embodiment, the present invention employs a POTS filter circuit which is a low-pass filter fulfilled by magnetic transformers based on ferrite cores. The POTS filter circuit also contains a capacitor which is connected in series with a passive switch and which is enabled or disabled by the switch.

There is a DC voltage impressed upon the line by the telephone company such that a voltage is always present. When a POTS device is not in use (on-hook), a switch internal to and part of the POTS device and separate from the switch in this invention, is open (OFF). Consequently, no direct current flows though the filter inductor(s), the normally-open switch in this invention is not magnetically activated and the capacitor is not connected in the filter circuit.

When a POTS device is in use (off-hook), the switch internal to and part of the POTS device and separate from the switch in this invention, is closed (ON). Consequently, direct current flows though the filter inductor(s), the normally-open switch in this invention is magnetically activated and the capacitor is connected in the filter circuit.

One of the advantages of the present invention is that it enables simultaneous multiple access of a DSL (Digital Subscriber line) channel by telephones, facsimile machines and/or other POTS communications devices connected to one installation interface in a number greater than possible with prior art filters.

Another advantage of the present invention is that the passive nature of the filter enables simultaneous multiple access of POTS communications devices connected to one installation interface without the drawbacks of active filters. Namely, the filter of the present invention is less complicated, does not draw power, and can be produced at a lower cost than active filters of the prior art.

Many modifications, variations, and combinations of the methods and systems of filtering are possible in light of the embodiments described herein. The description above and many other features and attendant advantages of the present invention will become apparent from a consideration of the following detailed description when considered in conjunction with the accompanying drawings.

### BRIEF DESCRIPTION OF THE DRAWINGS

A detailed description with regard to the embodiments in accordance with the present invention will be made with reference to the accompanying drawings; wherein:

FIG. 1 shows an exemplary system diagram of a filter circuit of the present invention which is adapted to mate with a POTS communication device;

FIG. 2 shows a perspective view of a ferrite core of a transformer; and

FIG. 3 shows a perspective view of a transformer with a magnetic switch installed inside.

### DETAILED DESCRIPTION OF THE PREFERRED EMBODIMENTS

The following description should not be taken in a limiting sense but is made for the purpose of illustrating the general principles of the invention. The section titles and overall organization of the present detailed description are for purposes of convenience only and are not intended to limit the present invention.

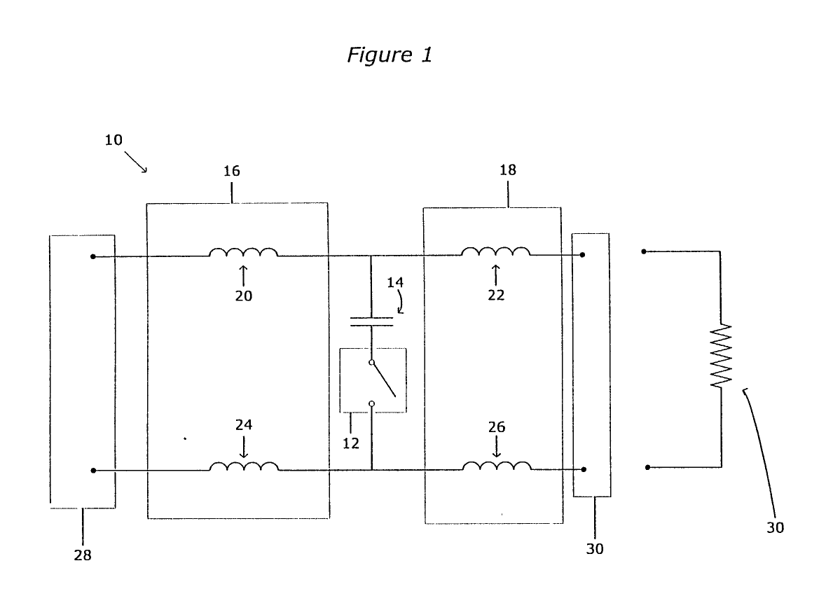

FIG. 1 shows an exemplary system diagram of a filter circuit of the present invention which is adapted to mate with a POTS line communication device and a POTS line. The filter circuit 10 contains a passive switch 12 which is connected in series to a filter capacitor 14. The capacitor and switch in series are connected to two filter transformers 16, 18 each with ferrite cores. The passive switch 12 is a magnetically activated switch which is designed to open in response to a magnetic field or close in response to a lack of a magnetic field. In the present embodiment, the passive magnetically activated switch is a miniature reed-switch having a low number of ampere-turns activation, and electrical leads composed of ferromagnetic metal. A device terminal 30 is adapted to communicatively couple to a POTS device such as a telephone, shown as a resistive load 30, and the line terminal 28 is adapted to communicatively couple to a POTS line.

If a POTS device 30 is communicatively coupled to the filter circuit 10, and is not in use (on-hook), the device terminal 30 will be an open circuit with respect to the POTS device 30 and no current flows through the windings (inductors) 20, 22, 24, 26 of the common-mode filter transformers 16, 18. Thus, there is no significant direct current magnetic field present and the magnetic reed switch 14 is open. When the POTS device is in use (off-hook), the device terminal 30 will be a closed circuit connected to the POTS device 30. A direct current will flow through the windings 20, 22, 24, 26 of the common-mode filter transformers 16, 18 and create a magnetic field in the ferrite core of both transformers 16, 18. The magnetic field in the core of the transformer, to which the switch is coupled to or in the proximity of, causes the switch to close, thereby connecting the capacitor 14 to the common-mode filter transformers 16, 18. The magnetic reed switch may be attached anywhere near the transformers such that the magnetic field produced by the transformer(s) is strong enough to activate the switch. A reed switch consists of a pair of low reluctance ferromagnetic reeds, which overlap at their free ends, the contact region. The electrical leads which connect to the reeds should also be ferromagnetic. This scheme provides higher magnetic coupling and lower magnetic reluctance. The most sensitive reed switches are those with long reeds and (ferromagnetic) leads.

Device terminal 30 and device terminal 28 are interchangeable; that is, either terminal may communicatively couple to the telephone and the remaining terminal to a POTS line. Moreover, the entire filtering apparatus 10 may be installed directly inside of a POTS communication device such as a telephone or modem or fax machine.

Once the capacitor 14 is connected to the common mode filter transformers 16, 18, the filter circuit 10 illustrated in FIG. 1 is equivalent to a tee-section (LCL) passive 3^{rd} order Chebyshev low-pass filter. The particular configuration of the Chebyshev filter is for exemplary purposes only and does not limit the scope of the present invention. Various filtering circuit designs, for example those which uses magnetic components for filtering based upon ferrite cores may be used to connect or disconnect a filtering capacitor within the filtering circuit via a magnetic reed switch.

By using the magnetic flux in the inductors of the low pass filter to activate or deactivate a switch, the present embodiment allows a low pass filter to be used on a POTS device whereby the filter capacitor is activated only when the POTS device is in use.

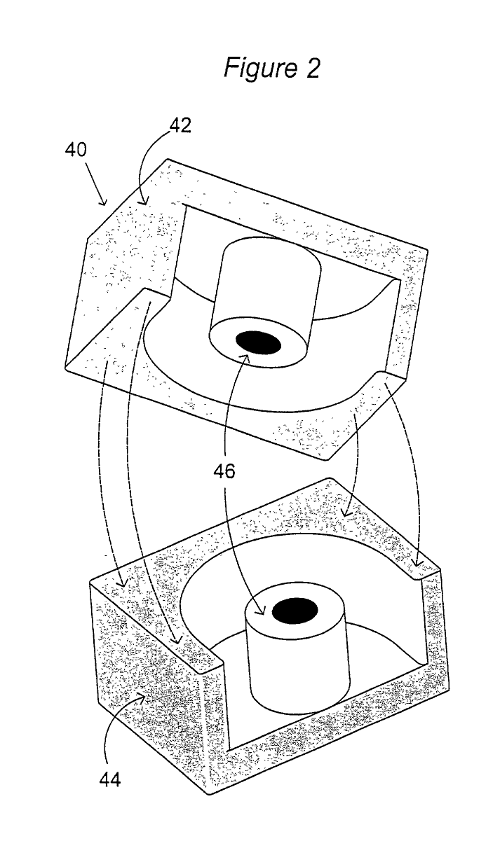

FIG. 2 shows a perspective view of an exemplary ferrite core of the transformer 16 or 18 shown in FIG. 1. The core 40, is composed of two solid portions 42, 44 of a ferrite material. The two core pieces 42, 44, are typically combined with two windings, which surround the center post 46 of the cores. When combined, an air gap is formed between the two center posts. The air gap in the center post must be sufficiently small to support the relatively large magnetic flux density required for the magnetic switch activation.

Also, the air gap must be sufficiently large so that the fringing flux of the magnetic field is efficiently coupled to the magnetic elements of the magnetic switch. In the present embodiment, an axially symmetric circular hole is drilled through the center axis of each center post 46. A 2-mm hole, for example, is drilled with a diamond drill or any other type of drill known to one in the art. The magnetic reed switch is installed in the axially symmetric circular hole of the assembled transformer. The hole may be drilled, and the magnetic switch installed, in either the first or the second transformer 16, 18. A portion of the switch 12 may be covered by heat shrinkable tubing to provide electrical insulation of the switch contacts from the ferrite core. Embedding the reed switch in a hole results in a large area for magnetic flux interception; hence, provides a high magnetic coupling and low magnetic reluctance. This implies a high magnetic flux density. Long ferromagnetic reeds and ferromagnetic leads in the switch intercept along their lengths residual magnetic flux escaping the surface of the magnetic core and magnetic fringing flux from the core gap and these magnetize the reeds.

Although the present embodiment describes the magnetic switch as being placed in an axially symmetric hole in the centerpost of the core of the transformer (or just an inductor), this location is for exemplary purposes only. In a preferred embodiment, the switch may be placed at any location within or nearby the transformer so as to maximize the magnetic flux on the switch. However, the location of the switch may be anywhere near or within the transformer so long as the magnetic field caused by a current going through a transformer can activate the magnetic switch. For example, a hole or a groove to accommodate a switch may be placed anywhere on the transformer. Furthermore, the hole may be non-axially symmetrically placed. It is within the scope of the present invention to use a variety of different core geometries and a variety of different locations for placement of the magnetic switch on, within, or near the transformer.

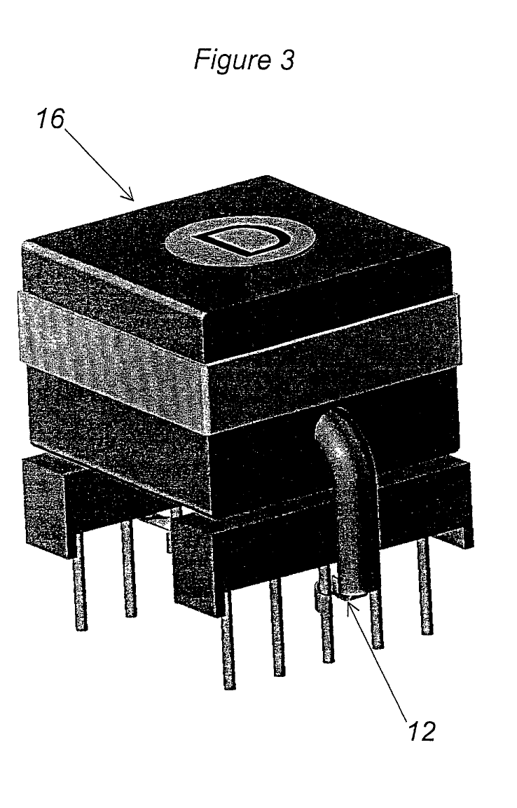

FIG. 3 shows a perspective view of the transformer in FIGS. 1 and 2, where the two core pieces are assembled together with other components to form the complete transformer. Although FIG. 3 refers to transformer 16 in FIG. 1, transformer 18 may also be used. The switch 12 is ideally positioned so that the center of the air gap, which is formed when the two core pieces 40 and 44 are put together (FIG. 2), bisects the contacts of the switch. This may be accomplished by installing the switch so that equal lengths of the switch contacts protrude from each side of the core. In FIG. 3, only one side of the transformer is shown with the switch 12 protruding out of the hole drilled in the center post 46.

In a preferred embodiment the circuit 10 illustrated in FIG. 1 has two cascaded ferrite-core common-mode transformers of EP13 geometry 16, 18. The use of the EP13 geometry is for exemplary purposes only. A wide variety of cores from the EP or other series such as the ER series may be used. The first transformer 16 may be two coils wound bifilarly, each having 250 turns of wire on EP13 bobbin. For example, the Ferroxcube (Philips) type CSH-EP13-1S-10P may be used. The direct current resistance R_{DC} for both coils measured in series for this example is approximately 13.04 ohms. The core may be a TDK H5C3EP13 with one center-post ground down to provide for the two coils to be connected in a series-aiding configuration. The open circuit inductance (OCL) is 22.6 millihenries at 10 kHz, 1 mARMS, with a hole drilled through the center axis of each centerpost. The measured air gap for the first transformer is 0.0068 inch or equivalent to 90.4 nanohenries per turn-squared.

The second transformer in this preferred embodiment may be two coils would bifilarly, each having 168 turns of #33 AWG SPN wire on EP13 bobbin. For example, Ferroxcube (Philips) type CSH-EP13-1S-10P may be used. The direct current resistance, R_{DC}, for both coils measured in series is approximately 5.35 ohms. The core may be a TDK H5C3EP13-A160 to provide open circuit inductance (OCL) of 18 millihenries at 10 kilohertz, 1 mARMS. The measured air gap for the first transformer is 0.00465 inch or equivalent to 160 nanohenries per turn-squared.

The magnetically activated reed switch in this preferred embodiment may be, for example, a Clare Reed switch, type Ultra Mini-Dyad UM2. A portion of the switch may be covered by heat shrinkable tubing, such as 3M flexible polyolefin. The shrinkable tubing provides electrical insulation of the reed switch contacts from the ferrite core. In this exemplary embodiment, the low-pass filter has approximately a 0.1 dB pass-band ripple, with the capacitor switched into the circuit in response to direct current flowing through the transformer windings.

The capacitor in this preferred embodiment may be, for example, a ceramic, X7R formulation 0.1 microfarad, 100V, such as a CK06BX104K.

In the present preferred embodiment, the magnetic flux created in the core activates the magnetic reed switch. In the present embodiment, approximately 11 mADC will activate the magnetic reed switch. When connected to a POTS line, the input impedance in the present embodiment is six-hundred ohms and the intended load impedance is six-hundred ohms. The switching innovation reduces the circuit loading on a POTS line in xDSL applications when more than one such circuit is connected in parallel.

Although specific components with particular operating parameters are described in the preferred embodiment a variety of different components with varying operating parameters may be used which do not depart from the scope of the present invention. The preferred embodiment described above is for exemplary purposes only. The invention applies to all types of combinations and/or rearrangements of the methods and systems described.

In closing, it is noted that specific illustrative embodiments of the invention have been disclosed hereinabove. However, it is to be understood that the invention is not limited to these specific embodiments. With respect to the claims, it is the applicant's intention that the claims not be interpreted in accordance with the sixth paragraph of 35 U.S.C. § 112 unless the term “means” is used followed by a functional statement.

What is claimed is:

1. A passive electrical filter apparatus for a POTS device, comprising:
a filtering capacitor;
an inductor having a ferrite core; and
a magnetic switch proximate the ferrite core and communicatively coupled to the filtering capacitor such that when a current is directed to the inductor, the inductor creates a magnetic field which closes the magnetic switch and enables the filtering capacitor.

2. The apparatus according to claim 1 wherein the magnetic switch is a reed switch.

3. The apparatus according to claim 2 wherein the magnetic switch has ferromagnetic leads.

4. The apparatus according to claim 1 wherein the ferrite core further includes a hole and the magnetic switch is disposed inside the hole.

5. The apparatus according to claim 4 wherein the hole is an axially symmetrical hole.

6. The apparatus according to claim 1 wherein the ferrite core further includes a groove and the magnetic switch is disposed within the groove.

7. A passive electrical filter apparatus, comprising:
a capacitor; and
a magnetic switch coupled to the capacitor such that when the magnetic switch is in the presence of a magnetic field of a predetermined strength, the capacitor is enabled and when the magnetic switch is not in the presence of the magnetic field of a predetermined strength, the capacitor is disabled.

8. The apparatus according to claim 7 wherein the magnetic switch is a reed switch.

9. The apparatus according to claim 8 wherein the magnetic switch has ferromagnetic leads.

10. A transformer for use in a passive electrical filter, comprising:
a core, having
a centerpost,
a base attached to the centerpost,
a sidewall attached to the base;
the core having a hole to accommodate a magnetic switch.

11. The transformer according to claim 10 wherein the hole is disposed in the centerpost.

12. The transformer according to claim 11 wherein the hole is positioned in an axially symmetric location.

13. The transformer according to claim 10 wherein the hole is disposed in the base.

14. The transformer according to claim 10 wherein the hole is disposed in the sidewall.

15. A passive electrical filter apparatus, comprising:
a first inductor;
a capacitor coupled to the first inductor;
a magnetic switch coupled to the capacitor;
a second inductor coupled to the switch and communicatively coupled to the first inductor such that when a current flows through the first and second inductor, a magnetic field is created in the first and second inductor which closes the magnetic switch and communicatively couples the capacitor to the second inductor.

16. The apparatus according to claim 15 wherein the magnetic switch is a reed switch.

17. The apparatus according to claim 16 wherein the magnetic switch has ferromagnetic leads.

18. A transformer for use in a passive electrical filter for a DSL, comprising:
a core having,
a first centerpost;
a second centerpost;
the first and second centerposts having a hole running through the centerposts to accommodate a magnetic switch.

19. The transformer according to claim 18 further including an air gap between the first and second centerposts to support a magnetic flux density for activating the magnetic switch and efficiently coupling the magnetic switch to a fringing flux.

20. A method for installing multiple POTS devices on a POTS DSL line comprising:
connecting a passive electrical filter to a POTS device;
connecting the passive electrical filter to a POTS line;
wherein the passive electrical filter is enabled when the POTS device is off-hook and the passive electrical filter is disabled when the POTS device is on-hook.

21. The method according to claim 20 further including:
installing the passive electrical filter within the POTS device;

22. The method according to claim 21 where in the POTS device is a telephone.

23. The method according to claim 20 wherein the passive electrical filter is a low pass filter.

24. The method according to claim 23 wherein the passive electrical filter is a passive chebychev 3^{rd} order low pass filter.
